(19) United States
(12) Patent Application Publication
(10) Pub. No.: US 2008/0037460 A1
(43) Pub. Date: Feb. 14, 2008

(54) BROADBAND WIRELESS ACCESS NETWORK AND METHOD FOR PROVIDING MULTICAST BROADCAST SERVICES WITHIN MULTICAST BROADCAST SERVICE ZONES

(76) Inventor: Muthaiah Venkatachalam, Beaverton, OR (US)

Correspondence Address: SCHWEGMAN, LUNDBERG & WOESSNER, P.A., P.O. BOX 2938, MINNEAPOLIS, MN, 55402, US

(21) Appl. No.: 11/464,438

(22) Filed: Aug. 14, 2006

(51) Int. Cl. H04Q 7/00

(52) U.S. Cl. 370/328

(57) ABSTRACT

Embodiments of a wireless access network and method for providing multicast broadcast services within multicast broadcast service zones are generally described herein. Other embodiments may be described and claimed. In some embodiments, a multicast broadcast service controller within a network gateway creates a multicast broadcast service zone of base stations by establishing time and frequency parameters for simultaneous multicast downlink transmissions to mobile stations within the MBS zone.

### TECHNICAL FIELD

The present invention pertains to wireless communication systems. Some embodiments relate to wireless access networks, such as broadband wireless access (BWA) networks. Some embodiments relate to single-frequency network (SFN) operations.

### BACKGROUND

In some conventional wireless access networks, each base station independently communicates with associated mobile stations. Each mobile station generally communicates with one base station at a time and may receive broadcast content from that one base station. In these conventional networks, broadcast content is generally transmitted to mobile stations on a per station basis.

One problem with these conventional networks is that when a mobile station roams between base stations, a handover is performed possibly interrupting the content flow. Another problem with these conventional networks is that a mobile station is unable to take advantage of diversity gain because it receives broadcast content from a single base station.

Thus, there are general needs for wireless access networks and methods that allow mobile stations to receive broadcast content without handovers while taking advantage of diversity gain.

### BRIEF DESCRIPTION OF THE DRAWINGS

FIG. 1 illustrates a broadband wireless access network in accordance with some embodiments of the present invention;

FIG. 2A illustrates downlink and uplink subframes in accordance with some embodiments of the present invention;

FIG. 2B illustrates downlink and uplink subframes in accordance with some alternate embodiments of the present invention;

FIG. 3 illustrates an end-to-end (E2E) architecture of broadband wireless access network in accordance with some embodiments of the present invention;

FIG. 4 illustrates an exchange of messages for the creation of a multicast broadcast service (MBS) zone in accordance with some embodiments of the present invention;

FIG. 5 illustrates an exchange of messages by various network entities for joining an existing MBS zone in accordance with some embodiments of the present invention; and

FIG. 6 illustrates the scheduling, aggregation and synchronization of transmissions by an MBS controller in accordance with some embodiments of the present invention.

### DETAILED DESCRIPTION

The following description and the drawings sufficiently illustrate specific embodiments of the invention to enable those skilled in the art to practice them. Other embodiments may incorporate structural, logical, electrical, process, and other changes. Examples merely typify possible variations. Portions and features of some embodiments may be included in, or substituted for, those of other embodiments. Embodiments of the invention set forth in the claims encompass all available equivalents of those claims. Embodiments of the invention may be referred to herein, individually or collectively, by the term “invention” merely for convenience and without intending to limit the scope of this application to any single invention or inventive concept if more than one is in fact disclosed.

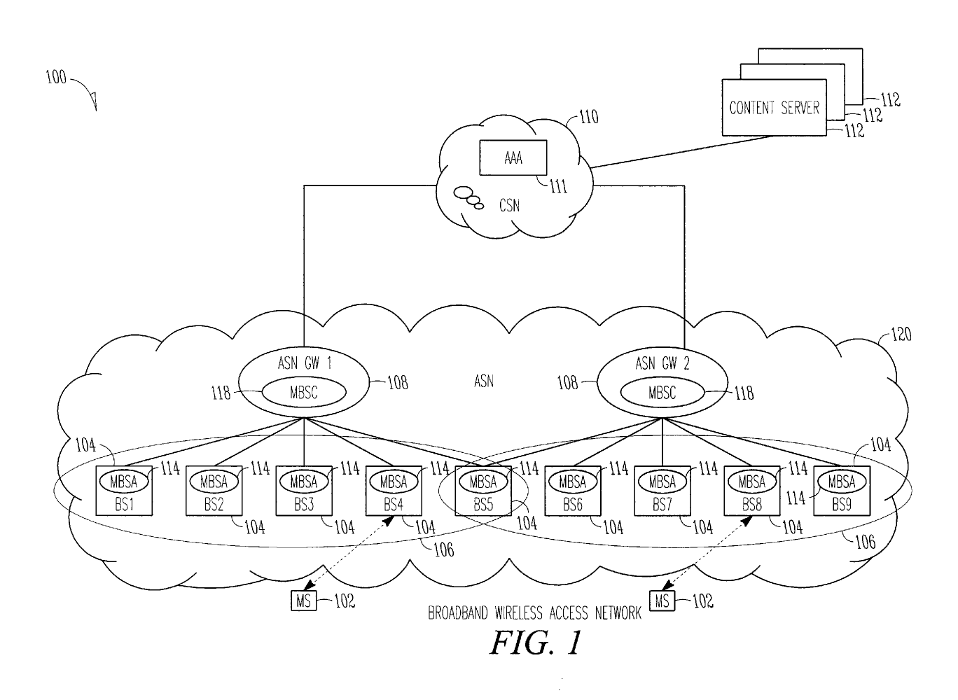

FIG. 1 illustrates a broadband wireless access network in accordance with some embodiments of the present invention. Wireless access network 100 comprises core service network (CSN) 110 and access service network (ASN) 120. Among other things, wireless access network 100 may receive content from one or more content servers 112 and may provide the content to one or more mobile stations (MS) 102. ASN 120 may include one or more gateways (GW) 108, illustrated as ASN GW 1 and ASN GW 2, and a plurality of base stations (BS) 104, illustrated as BS1 through BS9. CSN 110 may include authentication authorization accounting (AAA) server 111 which, among other things, may handle requests for access, among other things.

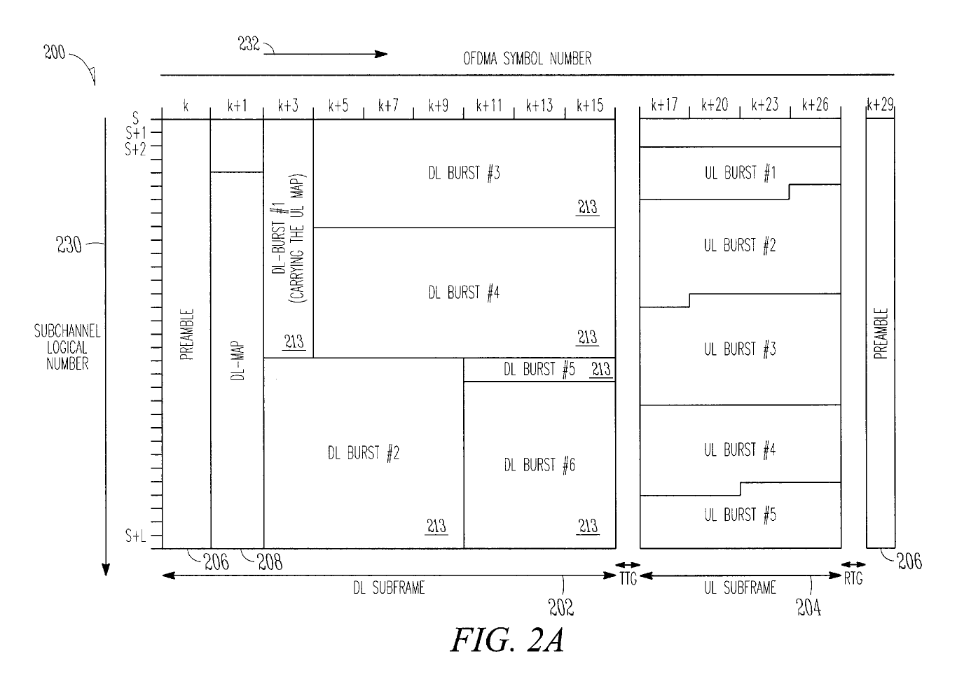

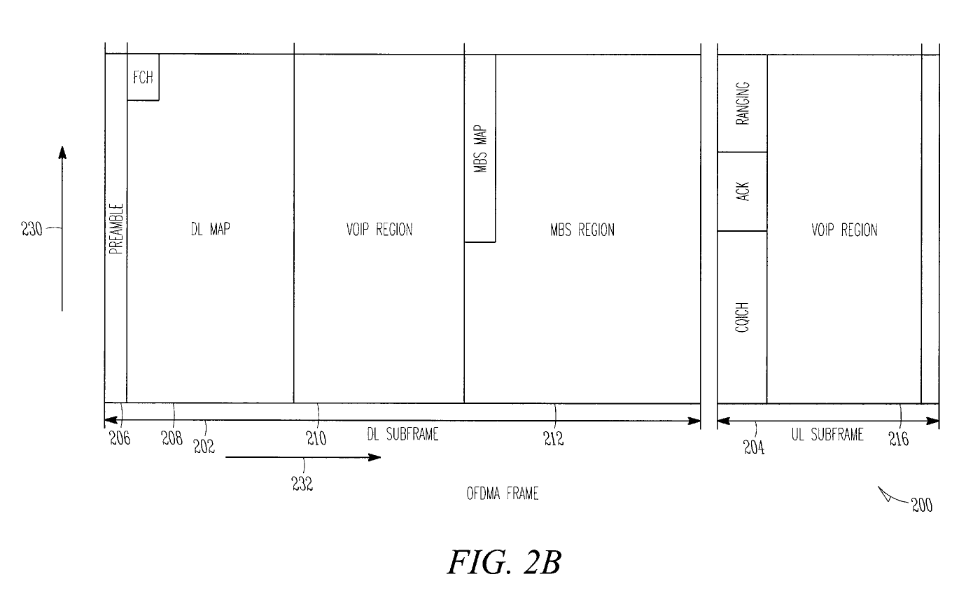

In accordance with embodiments, gateways 108 may include a multicast broadcast service controller (MBSC) 118. Each MBSC 118 may create one or more multicast broadcast service (MBS) zones 106, and each MBS zone 106 may comprise a plurality of base stations 104. MBSCs 118 may create MBS zones 106 by establishing specific time and frequency parameters for simultaneous multicast downlink transmissions to mobile stations 102 within a particular one of MBS zones 106. In these embodiments, base stations 104 may include MBS agents (MBSA) 114 to cause and/or instruct base stations 104 to synchronously transmit identical content within MBS regions of downlink subframes. The identical MBS regions may include multicast broadcast content identified by multicast connection identifiers (CIDs). Multicast broadcast services that may be provided by wireless access network 100 are discussed in more detail below. The MBS regions of downlink subframes are illustrated in FIGS. 2A and 2B, which are discussed in more detail below.

In some embodiments, wireless access network 100 may operate as a single-frequency network (SFN). In these embodiments, base stations 104 of a common MBS zone 106 may have their downlink and/or uplink subframes synchronized in both time and frequency allowing mobile stations 102 to receive multicast broadcast content from any base station 102 of a particular MBS zone 106 without having to perform handover operations within an MBS zone. In these embodiments, mobile stations 102 may take advantage of diversity gain achieved by receiving signals concurrently from more than one base station 104 of an MBS zone 106, which may result in an improved signal-to-noise ratio (SNR) at the mobile station 102. In these embodiments, multicast broadcast content may be provided within identical MBS regions of downlink subframes allowing mobile stations 102 to receive broadcast content from any one or more of base stations 102 of an MBS zone 106. These embodiments are described in more detail below. In some embodiments, one or more non single-frequency network (non-SFN) base stations (not illustrated) outside MBS zone 106 may transmit the multicast data non-synchronously, although the scope of the invention is not limited in this respect.

FIG. 2A illustrates downlink and uplink subframes in accordance with some embodiments of the present invention. FIG. 2B illustrates downlink and uplink subframes in accordance with some alternate embodiments of the present invention. As illustrated in FIG. 2A, MBS region 212 comprises a plurality of downlink (DL) bursts 213. Each downlink burst 213 may contain multicast broadcast content with a common CID. MBS regions 212 transmitted by base stations of a MBS group, such as MBS group 106 (FIG. 1), may have an identical burst structure allowing mobile stations 102 to receive the same multicast broadcast content from any base station 102 of an MBS group.

As illustrated in FIGS. 2A and 2B, downlink (DL) subframe 202 and uplink (UL) subframe 204 may be part of frame 200, which may be an orthogonal frequency division multiple access (OFDMA) frame. Downlink subframe 202 may be transmitted by one or more of base stations 104 (FIG. 1) for receipt by one or more mobile stations 102 (FIG. 1). Uplink subframe 204 may be transmitted by mobile stations 102 (FIG. 1) within an assigned uplink time slot. Downlink subframe 202 may include preamble 206, downlink map 208, Voice-over-IP (VoIP) region 210, and MBS region 212, among other things. Uplink subfame 204 may include an acknowledgement and management portion 214 and VoIP region 216, among other things.

In accordance with embodiments of the present invention, MBS region 212 may be used to transmit multicast data to mobile stations 102 (FIG. 1) as discussed above. In these embodiments, each MBS region 212 transmitted by a base station 102 (FIG. 1) within a common MBS zone, such as one of MBS zones 106 (FIG. 1), may be identical and may be synchronized in both time and frequency. As illustrated, MBS region 212 is a portion of downlink subframe 202. In some embodiments, MBS region 212 may comprise most or all of downlink subframe 202. In these embodiments, a group of two or more base stations 104 (FIG. 1) of MBS zone 106 (FIG. 1) may be configured to transmit downlink subframes 202 with identical content within their MBS regions 212.

The downlink and uplink subframes illustrated in FIGS. 2A and 2B may comprise a plurality of subchannels illustrated on frequency axis 230. Each subchannel may comprise group or set of individual subcarriers (s), such as orthogonal frequency division multiplexed (OFDM) subcarriers. The downlink and uplink subframes illustrated in FIGS. 2A and 2B may also comprise a plurality of symbols (k) in FIG. 2A on time axis 232. In some embodiments, the basic transmission unit for a downlink subframe may comprise two symbols on a single subchannel, and the basic transmission unit for an uplink subframe may comprise three symbols on a single subchannel, although the scope of the invention is not limited in this respect.

As illustrated in FIGS. 2A and 2B, downlink map 208 may include a frame control header (FCH). As illustrated in FIG. 2B, MBS region 212 may include an MBS map defining the structure of MBS region 212. As illustrated in FIG. 2A, a first downlink burst (DL burst #1) may include an uplink map defining the structure of uplink subframe 204. The structures of downlink subframe 202 and uplink subframe 204 illustrated in FIGS. 2A and 2B are meant to convey various example configurations, although the scope of the invention is not limited to either configuration.

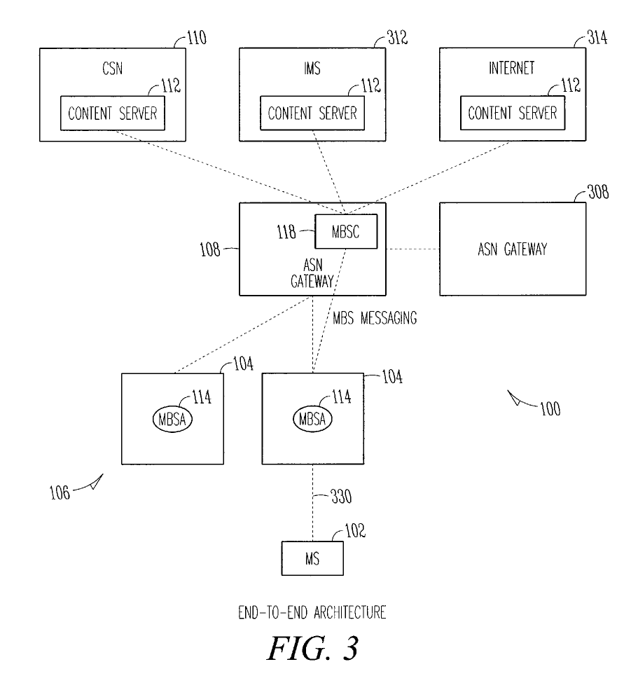

FIG. 3 illustrates an end-to-end (E2E) architecture of broadband wireless access network in accordance with some embodiments of the present invention. The E2E architecture illustrated in FIG. 3 may be suitable for wireless access network 100 (FIG. 1). As illustrated in FIG. 3, MBSC 118 resides in ASN gateway 108, and in some embodiments, may control one or more MBS zones 106. In embodiments, when there is no ASN gateway present in the ASN, such as ASN 120 (FIG. 1), MBSC 118 may be a stand-alone entity within the ASN. In accordance with embodiments, MBSC 118 may perform aggregations, transmissions, scheduling and synchronizations for broadcast data the MBS zones 106 it controls. MBSC 118 may also create MBS zones, delete MBS zones, and modify properties of existing MBS zones. As illustrated in FIG. 3, MBSAs 114 reside in base stations 104. MBSAs 114 may transmit MBS content over air interface 330 in a synchronized fashion to mobile stations 102 as discussed above and may assist MBSC 118 in management and control operations.

As illustrated in FIG. 3, content servers 112 may provide broadcast content and may reside in CSN 110, internet protocol (IP) multimedia subsystem (IMS) network 312 and/or Internet 314. The broadcast content may include, for example, music and/or video streaming, although the scope of the invention is not limited in this respect. In some embodiments, content servers 112 may feed MBS content to MBSC 118, which may serve as a focal point for further downlink transmissions within a wireless access network, such as wireless access network 100 (FIG. 1). In some embodiments, MBSC 118 may coordinate with MBSAs 114 of MBS zone 106 to ensure time and frequency synchronization of multicast broadcast content within MBS zone 106.

In some embodiments, several content servers 112 may feed multiple broadcast channels into a single MBS zone. In these embodiments, MBSC 118 may aggregate the content in a timely manner and feed the aggregated content to MBSAs 114. The operations of MBSC 118 are described in more detail below. As illustrated in FIG. 3, ASN gateway 108 may interface with other ASN gateways, such as ASN gateway 308.

Referring to FIGS. 1 and 3 together, in some embodiments, wireless access network 100 may use IP multicast techniques as part of its SFN operations. In these embodiments, MBSC 118 may be part of an IP multicast group and may receive broadcast content from the IP multicast group.

In some embodiments, IP multicast may be used within MBS zone 106. In these embodiments, for each MBS zone 106, MBSC 118 may set up a local IP multicast group to transmit the multicast broadcast content. In these embodiments, MBSC 118 may provide the multicast IP address for the MBS zone 106 to MBSAs 114 using the MBS primitives described below. These MBS primitives may include requests (REQs), responses (RSPs) and confirms (CNF).

Some examples of MBS primitives include: MBS-join-REQ, which may be sent from an MBSC to an MBSA; MBS-join-RSP, which may be sent from an MBSA to an MBSC; MBS-join-CNF, which may be sent from an MBSC to an MBSA; MBS-leave-REQ, which may be sent from an MBSA to an MBSC; MBS-leave-RSP, which may be sent from an MBSC to an MBSA; MBS-modify-REQ, which may be sent from an MBSC to an MBSA and vice versa; and MBS-modify-RSP, which may be sent from an MBSC to an MBSA and vice versa.

MBS operations performed by MBSC 118 for an MBS control path may include MBS zone creation, deletion, and/or modification. In addition, as part of the MBS operations, an MBSA may join an MBS zone when a mobile station joins, and an MBSA may leave an MBS zone when a mobile station leaves.

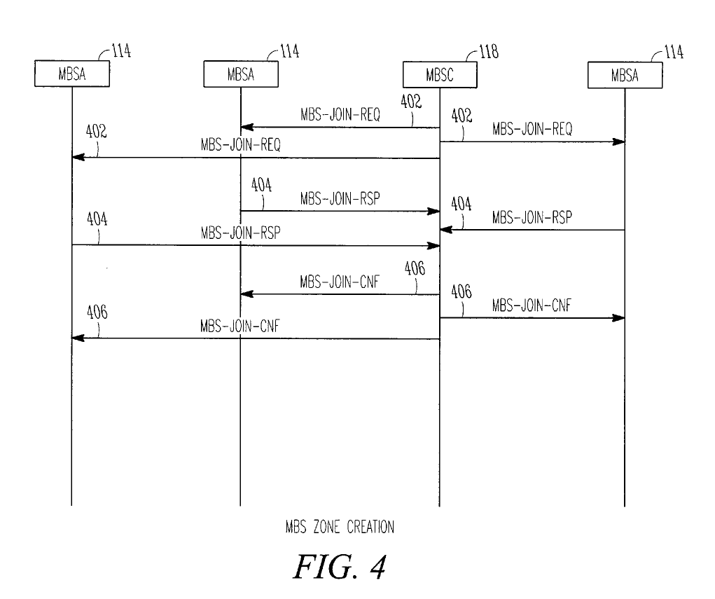

FIG. 4 illustrates an exchange of messages for the creation of a multicast broadcast service (MBS) zone in accordance with some embodiments of the present invention. As illustrated in FIG. 4, MBSC 118 may be in charge of an MBS zone, such as MBS zone 106 (FIG. 1), and may send MBS-join-REQ message 402 to MBSAs 114 asking the MBSAs 114 if they wish to be part of a particular MBS zone. MBSAs 114 may respond back with MBS-join-RSP messages 404, expressing their interest to join the MBS zone. MBSC 118 may respond back to MBSAs 114 with MBS-join-CNF messages 406. MBS-join-CNF messages 406 may include the radio parameters of the MBS zone, the network parameters and/or other relevant parameters. The radio parameters may include information about the size, location, periodicity, multicast CID, modulation and coding schemes used. The network parameters may include the multicast IP address of the multicast group for the MBS zone, although the scope of the invention is not limited in this respect.

In some embodiments, MBSC 118 may delete an MBS zone by sending an unsolicited MBS-leave-RSP message to MBSAs 114 in the MBS zone being deleted. In some embodiments, MBSC 118 may modify an MBS zone (e.g., change the location or the periodicity of the zone) by sending an unsolicited MBS-modify-RSP message to MBSAs 114 of the MBS zone being modified. In some embodiments, an MBS zone may be modified when one of MBSAs 114 sends a request for modification (e.g., via an MBS-modify-REQ message) to MBSC 118. MBSC 118 may respond back to each MBSA 114 of the MBS zone with a MBS-modify-RSP message.

In some embodiments, an MBSA may join an existing MBS zone. In some embodiments, an MBSA may wish to join an existing MBS zone when a mobile station wishes to receive MBS transmissions of the MBS zone or when the mobile station is being handed over from an MBSA of another zone.

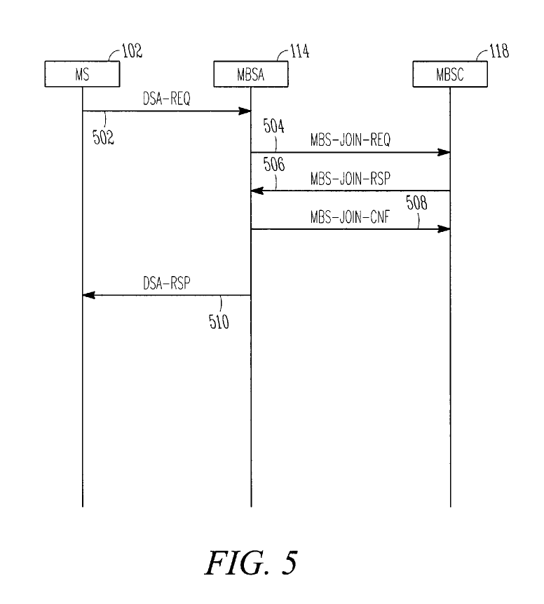

FIG. 5 illustrates an exchange of messages by various network entities for joining an existing MBS zone in accordance with some embodiments of the present invention. As illustrated in FIG. 5, mobile station (MS) 102 may send dynamic service addition request (DSA-REQ) message 502 to MBSA 114, requesting to join an MBS zone, such as one of MBS zones 106 (FIG. 1). In response, MBSA 114 may send MBS-join-REQ message to MBSC 118, and the MBS zone parameters may be e sent to MBSA 114 from MBSC 118 using MBS-join-RSP message 506 instead of a MBS-join-CNF message. MBSA 114 may send MBS-join-CNF message 508 to MBSC 118, and may send DSA-RSP message 510 to mobile station 102.

MBSAs 114 may leave an MBS zone 106 (FIG. 1) for one or more reasons including when the last mobile station to receive MBS transmissions in the MBS zone has tuned out or when a last mobile station is handed over to a new MBSA. In these situations, the message flow for leaving an MBS zone may be similar to the message flow for joining an MBSA discussed above.

In some embodiments, MBSC 118 may transmit additional MBS content within an MBS zone, such as MBS zone 106 (FIG. 1). In these embodiments, MBSC 118 may send an MBS modify request (e.g., MBS-MOD-REQ) to MBSAs 114 within the MBS zone to increase the size of MBS region 212 (FIGS. 2A and 2B) within downlink subframe 202 (FIGS. 2A and 2B) to accommodate the additional transmission. Similarly, when MBSC 118 reduces the amount of content within an MBS zone, it may send an MBS modify request message to the MBSAs 114 within the MBS zone to decrease the size of MBS region 212 (FIGS. 2A and 2B) within downlink subframe 202 (FIGS. 2A and 2B). In accordance with these embodiments, the MBS transmissions are synchronized in time and frequency across MBSAs 114 in a common MBS zone so that SFN operations and macro diversity gains may be achieved on the air interface.

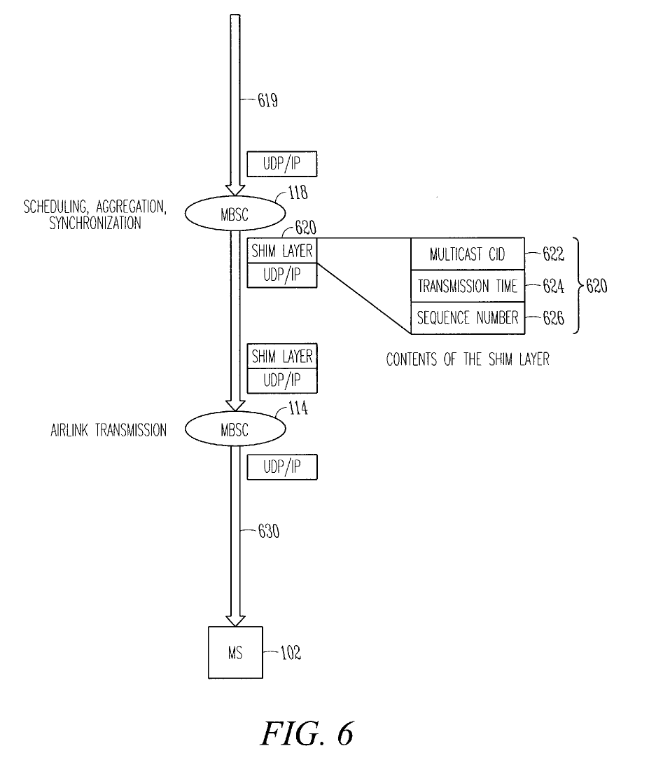

FIG. 6 illustrates the scheduling, aggregation and synchronization of transmissions by an MBS controller in accordance with some embodiments of the present invention. As illustrated in FIG. 6, MBSC 118 receives data packets 619, which may be universal datagram protocol (UDP)/IP data packets, although the scope of the invention is not limited in this respect. Data packets 619 may be received from an upstream source, such as one of content sources 112 (FIG. 1) and may comprise broadcast content of one or more different channels. Since data packets from the different channels are subsequently synchronized in time and frequency within MBS zone 106 (FIG. 1) when transmitted on air interface 630 by MBSAs 114, MBSC 118 adds shim layer 620 to the data packets before providing the data packets to MBSAs 114. MBSAs 114 may use the information in shim layer 620 to synchronize their transmissions. Shim layer 620 is removed by MBSAs 114 before transmission over air interface 630. As illustrated in FIG. 6, shim layer 620 may include multicast CID 622, which may be the CID on which the packet is transmitted over air interface 630, transmission time 624, which may indicate the future transmission time of MBS region 212 (FIG. 2A and FIG. 2B) in which this packet is sent, and sequence number 626, which may be a sequence number for the data packet. Because there may be multiple packets transmitted in a particular MBS region, MBSAs 114 may use sequence number 626 to order the packets prior to transmission. In this way, identical content and structure are maintained within MBS regions 212 transmitted by MBSAs 114 of two or more base stations 104 (FIG. 1).

Referring to FIG. 1, in some embodiments, base stations 104 and mobile stations 102 may communicate orthogonal frequency division multiplexed (OFDM) communication signals over a multicarrier communication channel. The multicarrier communication channel may be within a predetermined frequency spectrum and may comprise a plurality of orthogonal subcarriers. In some embodiments, the multicarrier signals may be defined by closely spaced OFDM subcarriers. In some wireless access network embodiments, base stations 104 and mobile stations 102 may communicate in accordance with a multiple access technique, such as OFDMA, although the scope of the invention is not limited in this respect. In some embodiments, wireless access network 100 may comprise a BWA network, such as a Worldwide Interoperability for Microwave Access (WiMax) network, although the scope of the invention is not limited in this respect.

In some embodiments, mobile stations 102 may be part of a portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, the frequency spectrums for the communication signals between base stations 104 and mobile stations 102 may comprise frequencies between 2 and 11 GHz, although the scope of the invention is not limited in this respect. In some wireless access network embodiments, base stations 104 and mobile stations 102 may communicate in accordance with the IEEE 802.16-2004 and the IEEE 802.16(e) standards for wireless metropolitan area networks (WMANs) including variations and evolutions thereof, although the scope of the invention is not limited in this respect as they may also be suitable to transmit and/or receive communications in accordance with other techniques and standards. For more information with respect to the IEEE 802.16 standards, please refer to “IEEE Standards for Information Technology—Telecommunications and Information Exchange between Systems”—Metropolitan Area Networks—Specific Requirements—Part 16: “Air Interface for Fixed Broadband Wireless Access Systems,” May 2005 and related amendments/versions.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Some embodiments of the invention may be implemented in one or a combination of hardware, firmware and software. Some embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus, the following claims are hereby incorporated into the detailed description, with each claim standing on its own as a separate preferred embodiment.

What is claimed is:

1. A wireless access network to provide multicast broadcast service (MBS) comprising:
a multicast broadcast service controller (MBSC) to create an MBS zone comprising a plurality of base stations by establishing time and frequency parameters for simultaneous multicast downlink transmissions from the plurality of base stations to mobile stations within the MBS zone; and
an MBS agent (MBSA) within each of the base stations to synchronously transmit identical MBS regions within downlink subframes, the identical MBS regions including multicast data identified by multicast connection identifiers (CIDs).

2. The network of claim 1 wherein the identical MBS regions are transmitted synchronously by each of the base stations of the MBS zone and comprise time and frequency synchronized portions of an orthogonal frequency division multiple access (OFDMA) frame, and
wherein each base station of the MBS zone transmits the same multicast data on the same subcarriers and at the same times within the MBS region.

3. The network of claim 1 wherein the MBSC adds a shim layer to multicast packets received from content servers, the shim layer to include a multicast CID, a transmission time and a packet sequence number for each of the multicast packets, and
wherein the MBSA of each base station of the MBS zone removes the shim layer and uses the sequence number, the transmission time and the multicast CID to generate the identical MBS regions within the downlink subframes for receipt by the mobile stations.

4. The network of claim 3 wherein the MBSC operates within a gateway of an access service network (ASN) to aggregate the multicast packets with common multicast CIDs in the shim layer for providing to the base stations.

5. The network of claim 4 wherein the MBSC provides a multicast internet-protocol (IP) address to the MBSAs of the base stations of the MBS zone to set-up a local IP multicast group, and
wherein the MBSC transmits the multicast data to the base stations of the MBS zone using the multicast IP address.

6. The network of claim 4 wherein the MBSC is one of a plurality of MBSCs that are part of a multicast IP group that receive broadcast content from one or more content servers.

7. The network of claim 1 wherein the multicast data comprises a plurality of broadcast channels from various content servers.

8. The network of claim 2 wherein the mobile stations use diversity gain to receive the identical MBS regions within downlink subframes from at least two or more of the base stations within the MBS zone for improved reception.

9. The network of claim 2 wherein the MBSC increases a size of the MBS regions when additional multicast data is to be transmitted by the base stations of the MBS zone,
wherein the MBSC decreases the size of the MBS regions when less multicast data is to be transmitted by the base stations of the MBS zone, and
wherein the size of the MBS zone is defined by a number of time-slots and subchannels within the OFDMA frame.

10. The network of claim 2 further comprising one or more non single-frequency network (SFN) base stations that transmit the multicast data non-synchronously with the base stations outside the MBS zone.

11. A method of providing multicast broadcast service (MBS) in a wireless access network comprising:
creating, by a multicast broadcast service controller (MBSC), an MBS zone comprising a plurality of base stations by establishing time and frequency parameters for simultaneous multicast downlink transmissions to mobile stations within the MBS zone; and
synchronously transmitting, by an MBSA (MBSA) within each of the base stations, identical MBS regions within downlink subframes by the base stations of the MBS zone, the identical MBS regions including multicast data identified by multicast connection identifiers (CIDs).

12. The method of claim 11 wherein the identical MBS regions are transmitted synchronously by each of the base stations of the MBS zone and comprise time and frequency synchronized portions of an orthogonal frequency division multiple access (OFDMA) frame, and
wherein the method further comprises transmitting by each base station of the MBS zone the same multicast data on the same subcarriers and at the same times within the MBS region.

13. The method of claim 11 further comprising:
adding, by the MBSC, a shim layer to multicast packets received from content servers, the shim layer to include a multicast CID, a transmission time and a packet sequence number for each of the multicast packets;
removing, by the MBSA of each base station of the MBS zone, the shim layer; and
using the sequence number, the transmission time and the multicast CID to generate the identical MBS regions within the downlink subframes for receipt by the mobile stations.

14. The method of claim 13 wherein the MBSC operates within a gateway of an access service network (ASN) to aggregate the multicast packets with common multicast CIDs in the shim layer for providing to the base stations,
wherein the method further comprises:
providing, by the MBSC, a multicast internet-protocol (IP) address to the MBSAs of the base stations of the MBS zone to set-up a local IP multicast group; and
transmitting, by the MBSCs the multicast data to the base stations of the MBS zone using the multicast IP address.

15. The method of claim 12 wherein the mobile stations use diversity gain to receive the identical MBS regions within downlink subframes from at least two or more of the base stations within the MBS zone for improved reception.

16. The method of claim 12 further comprising:
increasing a size of the MBS regions when additional multicast data is to be transmitted by the base stations of the MBS zone; and
decreasing the size of the MBS regions when less multicast data is to be transmitted by the base stations of the MBS zone,
wherein the size of the MBS zone is defined by a number of time-slots and subchannels within the OFDMA frame.

17. A system comprising:
a core service network; and
an access service network to receive multicast data from the core service network, the access service network comprising:
a multicast broadcast service controller (MBSC) to create a multicast broadcast service (MBS) zone comprising a plurality of base stations by establishing time and frequency parameters for simultaneous multicast downlink transmissions from the plurality of base stations to mobile stations within the MBS zone; and
an MBS agent (MBSA) within each of the base stations to synchronously transmit identical MBS regions within downlink subframes, the identical MBS regions including multicast data identified by multicast connection identifiers (CIDs).

18. The system of claim 17 wherein the identical MBS regions are transmitted synchronously by each of the base stations of the MBS zone and comprise time and frequency synchronized portions of an orthogonal frequency division multiple access (OFDMA) frame, and
wherein each base station of the MBS zone transmits the same multicast data on the same subcarriers and at the same times with in the MBS region.

19. The system of claim 18 wherein the MBSC adds a shim layer to multicast packets received from content servers, the shim layer to include a multicast CID, a transmission time and a packet sequence number for each of the multicast packets, and
wherein the MBSA of each base station of the MBS zone removes the shim layer and uses the sequence number, the transmission time and the multicast CID to generate the identical MBS regions within the downlink subframes for receipt by the mobile stations.

20. A machine-accessible medium that provides instructions, which when accessed, cause a machine to perform operations to schedule, aggregate and synchronize broadcast data to provide multicast broadcast service (MBS) in a wireless access network, the operations comprising:
creating, by a multicast broadcast service controller (MBSC), an MBS zone comprising a plurality of base stations by establishing time and frequency parameters for simultaneous multicast downlink transmissions to mobile stations within the MBS zone; and
synchronously transmitting, by an MBS agent (MBSA) within each of the base stations, identical MBS regions within downlink subframes by the base stations of the MBS zone, the identical MBS regions including multicast data identified by multicast connection identifiers (CIDs).

21. The machine-accessible medium of claim 20 wherein the identical MBS regions are transmitted synchronously by each of the base stations of the MBS zone and comprise time and frequency synchronized portions of an orthogonal frequency division multiple access (OFDMA) frame, and
wherein the instructions, when further accessed cause the machine to transmit by each base station of the MBS zone the same multicast data on the same subcarriers and at the same times within the MBS region.

22. The machine-accessible medium of claim 20 wherein the instructions, when further accessed cause the machine to:
add a shim layer to multicast packets received from content servers, the shim layer to include a multicast CID, a transmission time and a packet sequence number for each of the multicast packets;
remove, by the MBSA of each base station of the MBS zone, the shim layer; and
use the sequence number, the transmission time and the multicast CID to generate the identical MBS regions within the downlink subframes for receipt by the mobile stations.
